(19) United States
(12) Patent Application Publication
(10) Pub. No.: US 2015/0340027 A1
(43) Pub. Date: Nov. 26, 2015

(54) VOICE RECOGNITION SYSTEM

(71) Applicants: BOE TECHNOLOGY GROUP CO., LTD., Beijing (CN); BEIJING BOE DISPLAY TECHNOLOGY CO., LTD., Beijing (CN)

(72) Inventor: Jianming WANG, Beijing (CN)

(21) Appl. No.: 14/366,482

(22) PCT Filed: Apr. 26, 2013
(86) PCT No.: PCT/CN2013/074831

§ 371 Date: Jun. 18, 2014

(30) Foreign Application Priority Data
Mar. 29, 2013 (CN) 201310109044.3

(51) Int. Cl. G10L 15/08; G10L 15/07; G10L 15/02; G10L 19/00

(52) U.S. Cl. CPC G10L 15/08; G10L 19/0019; G10L 15/07; G10L 15/02

(57) ABSTRACT

A voice recognition system includes: a storage unit for storing a voice model of at least one user; a voice acquiring and preprocessing unit for acquiring a voice signal to be recognized, performing a format conversion on the voice signal to be recognized and encoding it; a feature extracting unit for extracting a voice feature parameter from the encoded voice signal to be recognized; a mode matching unit for matching the extracted voice feature parameter with at least one voice model and determining the user that the voice signal to be recognized belongs to. The voice recognition system analyzes the characteristics of the voice starting from the generating principle of the voice, and establishing the voice feature mode of the speaker by using the MFCC parameter to realize the feature recognition algorithm of the speaker, through which the purpose of increasing the speaker detection reliability can be achieved, so that the function of recognizing the speaker can finally be implemented on the electronic products.

### TECHNICAL FIELD

The present disclosure relates to the field of voice detection technology, in particular to a voice recognition system.

### BACKGROUND

At present, in the electronic product development of telecommunication, service industry and industrial production line, many products have adopted the voice recognition technology and a number of novel voice products such as a voice notepad, a voice control toy, a voice remote controller and a home server and the like have been created, thereby greatly lightening the labor intensity, improving the working efficiency, and increasingly changing the daily life of the people. Therefore, the voice recognition technology is considered as one of the most challenging and prospective application techniques of the present century.

The voice recognition comprises speaker recognition and speaker semantic recognition. The speaker recognition utilizes personality characteristics of the speaker in voice signal, does not consider meanings of words contained in the voice, and emphasizes the personality of the speaker; while the speaker semantic recognition aims at recognizing the semantic content in the voice signal, does not consider the personality of the speaker, and emphasizes the commonality of the voice.

However, technology of recognizing the speaker in the prior art does not have the high reliability, such that the voice products that adopt the speaker detection cannot be widely applied.

### SUMMARY

Given that, the technical problem to be solved by the technical solution of the present disclosure is how to provide a voice recognition system being capable of improving the reliability of the speaker detection, so as to make the voice products be widely applied.

In order to solve the above technical problem, provided is a voice recognition system according to one aspect of the present disclosure. The voice recognition system comprises:

a storage unit for storing at least one of voice models of users;

a voice acquiring and preprocessing unit for acquiring a voice signal to be recognized, performing a format conversion and encoding of the voice signal to be recognized;

a feature extracting unit for extracting a voice feature parameter from the encoded voice signal to be recognized;

a mode matching unit for matching the extracted voice feature parameter with at least one of the voice models and determining the user that the voice signal to be recognized belongs to.

Optionally, in the above voice recognition system, after the voice signal to be recognized is acquired, the voice acquiring and preprocessing unit is further used for amplifying, gain controlling, filtering and sampling the voice signal to be recognized in sequence, then performing a format conversion on the voice signal to be recognized and encoding it, so that the voice signal to be recognized is divided into a short-time signal composed of multiple frames.

Optionally, in the above voice recognition system, the voice acquiring and preprocessing unit is further used for performing a pre-emphasis processing on the format-converted and encoded voice signal to be recognized with a window function.

Optionally, the above voice recognition system further comprises:

an endpoint detecting unit for calculating a voice starting point and a voice ending point of the format-converted and encoded voice signal to be recognized, removing a mute signal in the voice signal to be recognized and obtaining a time-domain range of the voice in the voice signal to be recognized; and for making an analysis of the fast Fourier transform FFT on voice spectrum in the voice signal to be recognized and calculating a vowel signal, a voiced sound signal and a voiceless consonant signal in the voice signal to be recognized according to an analysis result.

Optionally, in the above voice recognition system, the feature extracting unit obtains the voice feature parameter by extracting a Mel frequency cepstrum coefficient MFCC feature from the encoded voice signal to be recognized.

Optionally, the voice recognition system further comprises: a voice modeling unit for establishing a Gaussian mixture model being independent of a text as an acoustic model of the voice with the Mel frequency cepstrum coefficient MFCC by using the voice feature parameter.

Optionally, in the above voice recognition system, the mode matching unit matches the extracted voice feature parameter with at least one voice model by using the Gaussian mixture model and adopting a maximum posterior probability MAP algorithm and calculates a likelihood of the voice signal to be recognized and each of the voice models.

Optionally, in the above voice recognition system, the mode of matching the extracted voice feature parameter with at least one voice model by using the maximum posterior probability MAP algorithm and determining the user that the voice signal to be recognized belongs to in particular adopts the following formula:

$${{θ}^{⋒}}_{i} = {arg}_{{θ}_{i}} max P ( θ \vert χ ) = {arg}_{{θ}_{i}} max \frac{P ( χ \vert {θ}_{i} ) P ( {θ}_{i} )}{P ( χ )}$$

Where θᵢ represents a model parameter of the voice of the i^{th} speaker stored in the storage unit, χ represents a feature parameter of the voice signal to be recognized; P(χ), P(θᵢ) represent a priori probability of θᵢ, χ respectively; P(χ/θᵢ) represents a likelihood estimation of the feature parameter of the to-be-identified voice speech relative to the i^{th} speaker.

Optionally, in the above voice recognition system, by using the Gaussian mixture model, the feature parameter of the voice signal to be recognized is uniquely determined by a set of parameters {wᵢ′ \vec{μ}ᵢ′ Cᵢ}, where wᵢ, \vec{μ}ᵢ, Cᵢ represent a mixed weighted value, a mean vector and a covariance matrix of the voice feature parameter of the speaker.

Optionally, the above voice recognition system further comprises a determining unit used for comparing the voice model having a maximum likelihood relative to the voice signal to be recognized with a predetermined recognition threshold and determining the user that the voice signal to be recognized belongs to.

The technical solution of the exemplary embodiments of the present disclosure has at least the following beneficial effects:

the characteristics of the voice is analyzed starting from the producing principle of the voice, and the voice feature mode of the speaker is established by using the MFCC parameter to realize the feature recognition algorithm of the speaker so that the purpose of increasing the speaker detection reliability can be achieved, and finally the function of recognizing the speaker can be implemented on the electronic products.

### BRIEF DESCRIPTION OF THE DRAWINGS

FIG. 1 illustrates a schematic diagram of a structure of a voice recognition system of exemplary embodiments of the present disclosure;

FIG. 2 illustrates a schematic diagram of a processing of a voice recognition system of exemplary embodiments of the present disclosure in a voice acquiring and preprocessing stage;

FIG. 3 illustrates a schematic diagram of a principle that a voice recognition system of exemplary embodiments of the present disclosure performs a voice recognition;

FIG. 4 illustrates a schematic diagram of a voice output frequency adopting a MEL filter.

### DETAILED DESCRIPTION

In order to make the technical problem to be solved, the technical solutions, and advantages in the embodiments of the present disclosure clearer, a detailed description will be given below in combination with the accompanying drawings and the specific embodiments.

FIG. 1 illustrates a schematic diagram of a structure of a voice recognition system of exemplary embodiments of the present disclosure. As shown in FIG. 1, the voice recognition system comprises:

a storage unit 10 for storing at least one of voice models of users;

a voice acquiring and preprocessing unit 20 for acquiring a voice signal to be recognized, performing a format conversion and encoding of the voice signal to be recognized;

a feature extracting unit 30 for extracting a voice feature parameter from the encoded voice signal to be recognized;

a mode matching unit 40 for matching the extracted voice feature parameter with at least one of the voice models and determining the user that the voice signal to be recognized belongs to.

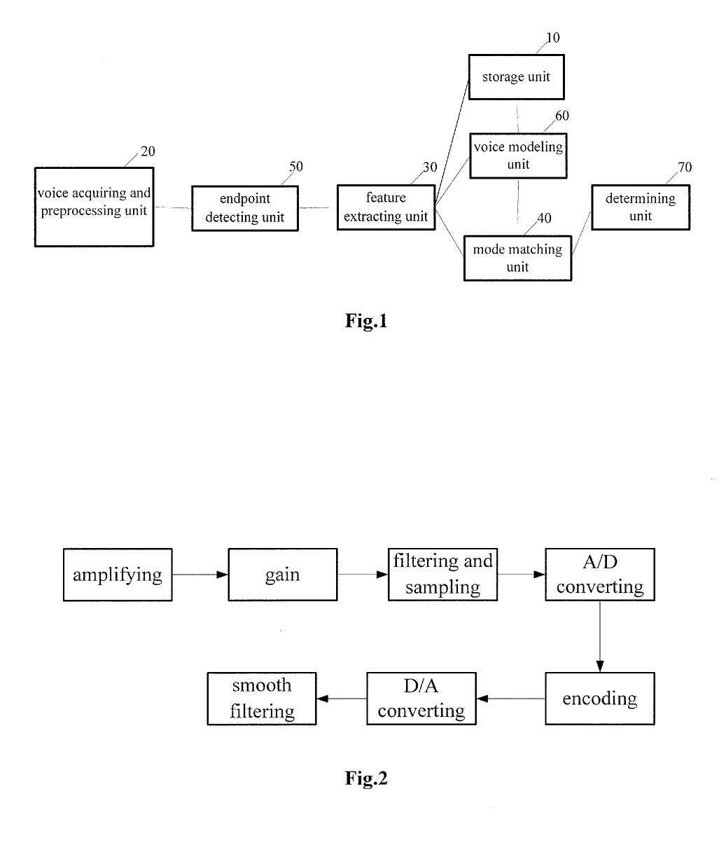

FIG. 2 illustrates a schematic diagram of a processing of a voice recognition system in a voice acquiring and preprocessing stage. As shown in FIG. 2, after the voice signal to be recognized is acquired, the voice acquiring and preprocessing unit 20 performs amplifying, gain controlling, filtering and sampling of the voice signal to be recognized in sequence, then performs a format conversion and encoding of the voice signal to be recognized, so that the voice signal to be recognized is divided into a short-time signal composed of multiple frames. Optionally, a pre-emphasis processing can be performed on the format-converted and encoded voice signal to be recognized with a window function.

In the technology of speaker recognition, voice acquisition is in fact a digitization process of the voice signal. The voice signal to be recognized is filtered and amplified through the processes of amplifying, gain controlling, anti-aliasing filtering, sampling, A/D (analog/digital) converting and encoding (it is generally a pulse-code-modulation (PCM) code), and the filtered and amplified analog voice signal is converted to the digital voice signal.

In the above process, by performing a filtering process, the purpose of suppressing all the components in the respective frequency domain of an input signal with a frequency exceeding fs/2 (fs is a sampling frequency) to prevent aliasing interference, and at the same time the purpose of suppressing power supply frequency interference of 50 Hz are achieved.

In addition, as shown FIG. 2, the voice acquiring and reprocessing unit 20 can be further used for performing a digitalized anti-processing on the encoded voice signal to be recognized, so as to reconstruct a voice waveform from the digitalized voice, i.e., performing the D/A (digital/analog) conversion. In addition, it is further needed to perform a smooth filtering after the D/A conversion to perform smoothing processing on high order harmonic of the reconstructed voice waveform, so as to remove the high order harmonic distortion.

Through the processes described above, the voice signal has been already divided into a short-time signal frame by frame. Then, each of the short-time voice frames is taken as stable random signal, and the voice feature parameter is extracted by using the digital signal processing technology. When performing the processing, data is extracted from a data area by frame, and the next frame is extracted after the processing is completed, and so on. Finally, a time sequence of the voice feature parameter composed of each frame is obtained.

In addition, the voice acquiring and reprocessing unit 20 can be further used for pre-emphasis processing the format-converted and encoded voice signal to be recognized with a window function.

Herein, the preprocessing generally comprises pre-emphasizing, windowing, and framing and the like. Since the average power spectrum of the voice signal is affected by glottal excitation and snout radiation, the high frequency above approximately 800 Hz drops by 6 dB/octave, i.e., 6 dB/oct (2 octaves), 20 dB/dec (10 octaves). In general, the higher the frequency is, the smaller the amplitude is. When the power of the voice signal reduces by one half, the amplitude of the power spectrum will have a drop of half magnitude. Therefore, the voice signal needs to be raised commonly before the voice signal is analyzed.

The window function commonly used in the voice signal processing is a rectangular window and a Hamming window and the like, which are used for windowing the sampled voice signal and dividing the same into a short-time voice sequence frame by frame. The expressions for the rectangular window and the Hamming window are as follows respectively: (where N is the frame length):

$$Rectangular window \text{:} w ( n ) = \{ \begin{matrix}1 , 0 \leq n \leq N - 1 \\ 0 , n = others\end{matrix} \\ Hamming window \text{:} w ( n ) = \{ \begin{matrix}0.54 - 0.46 cos [ 2 π n / ( N - 1 ) ] , 0 \leq n \leq N - 1 \\ 0 , n = others\end{matrix}$$

In addition, referring to FIG. 1, the voice recognition system further comprises an endpoint detecting unit 50 used for calculating a voice starting point and a voice ending point of the format-converted and encoded voice signal to be recognized, removing a mute signal in the voice signals to be recognized and obtaining a time-domain range of the voice in the voice signal to be recognized; and used for making an analysis of the fast Fourier transform FFT on voice spectrum in the voice signal to be recognized and calculating a vowel signal, a voiced sound signal and a voiceless consonant signal in the voice signal to be recognized according to an analysis result.

The voice recognition system determines by the endpoint detecting unit 50 the starting point and ending point of the voice from a segment of voice signal to be recognized which contains the voice to minimize the time for processing and thus eliminate noise interference of the silent voice segment, so that the voice recognition system has high recognition performance.

The voice recognition system of the exemplary embodiments of the present invention is based on a voice endpoint detection algorithm of correlation: the voice signal has correlation while the background noise does not have correlation. Therefore, the voice can be detected by using the difference in correlation, and in particular, the unvoiced sound can be detected from the noise. At a first stage, a simple real-time endpoint detection is performed for the input voice signal according to the changes of energy and zero crossing rate thereof, so as to remove the mute sound and obtain the time-domain range of the input voice, based on which the spectrum feature extracting is performed. At a second stage, the energy distribution characteristics of high frequency band, middle frequency band and low frequency band are respectively calculated according to the FFT analysis result of the input voice spectrum to determine a voiceless consonant, a voiced consonant and vowel; after segments of the vowel and voiced sound are determined, it is expanded to the front and rear ends to search frames including the voice endpoint.

The feature extracting unit 30 extracts from the voice signal to be recognized the voice feature parameters, comprising a linear prediction coefficient and its derived parameter (LPCC), a parameter directly derived from the voice spectrum, a hybrid parameter and a Mel frequency cepstrum coefficient (MFCC) and the like.

For the linear prediction coefficient and its derived parameter:

Among the parameters obtained by performing an orthogonal transformation on the linear prediction parameters, those with a relatively higher order have a smaller variance, this indicates that they have weak correlation in substance with the content of the sentence, and thus reflects the information of the speaker. In addition, since these parameters are obtained by averaging the whole sentence, it is not needed to make time normalization, and thus they can be used for the speaker recognition to be independent of the text.

For parameter directly derived from the voice spectrum:

The voice short-time spectrum comprises characteristics of an excitation source and a sound track, and thus it can reflect physically the distinctions of the speaker. Furthermore, the short-time spectrum changes with time, which reflects the pronunciation habits of the speaker to a certain extent. Therefore, the parameter derived from the voice short-time spectrum can be effectively used for the speaker recognition. The parameters having already been used comprise power spectrum, pitch contour, formant and bandwidth thereof, phonological strength and changes thereof, and the like.

For the Hybrid Parameter:

In order to increase the recognition rate of the system, partially because it is not clear enough which parameters are crucial, a considerable number of systems adopt a vector composed of hybrid parameters. For example, there exist the parameter combination methods such as combining a “dynamic” parameter (the logarithm area ratio and changes of radical frequency with time) with a “statistic” component (derived from the long-time average spectrum), combining an inverse filter spectrum with a band-pass filter spectrum, or combining a linear prediction parameter with a pitch contour. If there is minor correlation among respective parameters composing the vector, the effect will be very good, because these parameters reflect respectively different characteristics in the voice signal.

For Other Robust Parameters:

There includes Mel frequency cepstrum coefficient (MFCC), and denoising cepstrum coefficient via noise spectral subtraction or channel spectral subtraction.

Herein, the MFCC parameter has the following advantages (compared with the LPCC parameter):

Most of the voice information is concentrated at the low frequency part while the high frequency part is easy to be interfered by the environmental noise; the MFCC parameter converts the linear frequency scale into the Mel frequency scale and emphasizes the low frequency information of the voice. As a result, besides having the advantages of LPCC, the MFCC parameter highlights the information being beneficial for recognition, thereby blocking out the interference of the noise. The LPCC parameter is based on the linear frequency scale, and thus does not have such characteristics.

The MFCC parameter does not need any assumption, and may be used in various situations. However, the LPCC parameter assumes that the processed signal is an AR signal, and such assumption is strictly untenable for consonants with strong dynamic characteristics. Therefore, the MFCC parameter is superior to the LPCC parameter in view of recognition of the speaker.

In the process of extracting the MFCC parameter, FFT transform is needed, based on which all information in the frequency domain of the voice signal can be obtained.

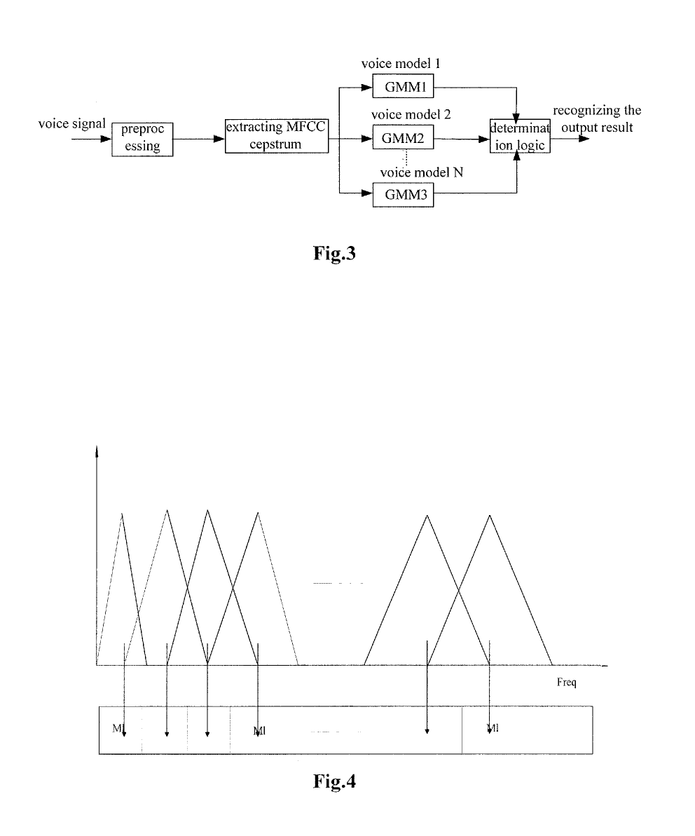

FIG. 3 illustrates the principle that a voice recognition system of exemplary embodiments of the present disclosure performs the voice recognition. As shown in FIG. 3, a feature extracting unit 30 is used to obtain a voice feature parameter by extracting the Mel frequency cepstrum coefficient MFCC feature from the encoded voice signal to be recognized.

In addition, the voice recognition system further comprises: a voice modeling unit 60 used for establishing a Gaussian mixture model being independent of a text as an acoustic model of the voice with the Mel frequency cepstrum coefficient MFCC by using the voice feature parameter.

A mode matching unit 40 matches the extracted voice feature parameter with at least one voice model by using the Gaussian mixture model and adopting a maximum posterior probability algorithm (MAP), so that a determining unit 70 determines the user that the voice signal to be recognized belongs to according to the matching result. As such, a recognition result is obtained by comparing the extracted voice feature parameter with the voice model stored in the storage unit 10.

The mode for performing voice modeling and mode matching by adopting specifically the Gaussian mixture model can be as follows:

In the set of the speakers adopting the Gaussian mixture model, the model form of any one of speakers is the same, and his personality characteristics are uniquely determined by a set of parameters λ={wᵢ, \vec{μ}ᵢ, Cᵢ}, where wᵢ, \vec{μ}ᵢ, Cᵢ, represent a mixed weighted value, a mean vector and a covariance matrix of the voice feature parameter of the speaker respectively. Therefore, the training of the speakers is to obtain such a set of parameters λ from the voice of the known speakers so that the probability density that the parameter generates the training voice is maximal. The recognition of the speaker is to select, depending on the principle of maximum probability, the speaker represented by the set of parameters that have the maximum probability for recognizing the voice, that is, referring to the formula (1):

λ=arg_{λ}maxP(X|λ) (1)

where P(X|λ) represents the likelihood of the training sequence X={X₁, X₂, . . . X_{T}} with a length of T (T feature parameters) with respect o the Gaussian mixture model (GMM):

specifically:

$$P ( X / λ ) = {\prod }_{t = 1}^{T} P ( {X}_{t} / λ ) \qquad ( 2 )$$

Below is a Process of the MAP Algorithm:

in the speaker recognition system, if χ is a training sample, θᵢ is a model parameter of the i^{th} speaker, according to the maximum posterior probability principle and the formula 1, the voice acoustic model determined from the MAP training method rule is the following formula (3):

$${{θ}^{⋒}}_{i} = {arg}_{{θ}_{i}} max P ( θ \vert χ ) = {arg}_{{θ}_{i}} max \frac{P ( χ \vert {θ}_{i} ) P ( {θ}_{i} )}{P ( χ )} \qquad ( 3 )$$

In the above formula (3), P(χ), P(θᵢ) represent a priori probability of θᵢ, χ respectively; P(χ/θᵢ) represents a likelihood estimation of the feature parameter of the voice signal to be recognized relative to the i^{th} speaker.

For the likelihood calculation of GMM in the above formula 2, it is difficult to get the maximum value of the above equation since the formula 2 is a non-linear function of the parameter λ. Therefore, the parameter λ is always estimated by adopting the Expectation Maximization (referred to as EM for short). The calculation of the EM algorithm starts from an initial value of the parameter λ, and a new parameter \hat{λ} is estimated using the EM algorithm, so that the likelihood of the new model parameter satisfies P(X/\hat{λ})≧P(X/λ). Then, the new model parameter is taken as the current parameter to be trained, and such iterative operation is always performed until the mode is convergent. For each iterative operation, the following re-estimation formula guarantees the monotonic increase of the model likelihood.

(1) The Re-Estimation Formula of the Mixed Weighted Value:

$${ω}_{i} = \frac{1}{T} {\sum }_{t = 1}^{T} P ( i / {X}_{t} , λ )$$

(2) The Re-Estimation Formula of the Mean Value:

$${μ}_{i} = \frac{{\sum }_{t = 1}^{T} P ( i / {X}_{t} , λ ) {X}_{t}}{{\sum }_{i = 1}^{T} P ( i / {X}_{t} , λ )}$$

(3) The Re-Estimation Formula of the Variance:

$${σ}_{i}^{2} = \frac{{\sum }_{t = 1}^{T} P ( i / {X}_{t} , λ ) {( {X}_{t} - {μ}_{i} )}^{2}}{{\sum }_{t = 1}^{T} P ( i / {X}_{t} , λ )}$$

where the posterior probability of the component i is:

$$P ( i / {X}_{t} , λ ) = \frac{{ω}_{i} {b}_{i} ( {X}_{t} )}{{\sum }_{k = 1}^{M} {ω}_{k} {b}_{k} ( {X}_{t} )}$$

When GMM is trained by using the EM algorithm, the number M of the Gaussian component of the GMM model and the initial parameter of the model must be firstly determined. If the value of M is too small, then the trained GMM model cannot effectively describe the features of the speaker, so that the performance of the whole system is reduced. If the value of M is too large, then there are many model parameters, and a convergent model parameter cannot be obtained from the effective training data. Meanwhile, the model parameter obtained by training may have a lot of errors. Furthermore, too many model parameters require more space for storing, and the operation complexity for training and recognizing will greatly increase. It is difficult to theoretically derive the magnitude of the Gaussian component M, which may be determined via experiment depending on different recognition systems.

In general, the value of M may be 4, 8, 16, etc. There may use two kinds of methods for initializing the model parameters: the first method uses an HMM model being independent of the speaker to automatically segment the training data. The training data voice frames are divided into M different categories according to their characteristics (where M is the number of the number of mixtures), which are corresponding to the initial M Gaussian components. The mean value and variance of each category is taken as the initial parameters of the model. Although there is an experiment to prove that the EM algorithm is insensitive to the selection of the initial parameters, the first method is obviously superior in training to the second method. It may firstly adopt a clustering method to put feature vectors into respective categories with the equal number of mixtures, and then calculate the variance and the mean value of the respective categories as an initial matrix and mean value. The weight value is the percentage of the number of the feature vectors contained in the respective categories to the total feature vectors. In the established model, the variance matrix may be a complete matrix or a diagonal matrix.

The voice recognition system of the present disclosure matches the extracted voice feature parameter with at least one voice model by adopting the maximum posterior probability algorithm (MAP) using the Gaussian mixture model (GMM), and determines the user that the voice signal to be recognized belongs to.

Using the maximum posterior probability algorithm (MAP) is to use a Bayes studying method to amend the parameters, which firstly starts from a given initial model λ to calculate statistical probabilities in each of the Gaussian distribution for each feature vector in the training corpus, utilizes these statistical probabilities to calculate an expectation value of each Gaussian distribution, and then conversely maximizes the parameter value of the Gaussian mixture model with these expectation values to obtain λ̅. The above steps are repeated until P(X|λ) is convergent. When the training corpus is much enough, the MAP algorithm has a theoretical optimum.

When it is given that χ is a training sample, θᵢ is a model parameter of the i^{th} speaker, according to the maximum posterior probability principle and the formula 1, after it is determined from the MAP training method criterion that the voice acoustic model is the above formula (3), the obtained \hat{θ}ᵢ is a Bayes estimation value of the model parameter. When considering the case that P(χ) and {θᵢ}_{i=1,2, . . . W} (W is the number of the word entries) is uncorrelated with each other: \hat{θ}ᵢ=arg_{θ}_{ᵢ}max P(χ|θᵢ)P(θᵢ), in a progressive adaptive mode, the training samples are inputted one by one. When it is given that λ={pᵢ, μᵢ, Σᵢ}, i=1, 2, . . . , M is a training sample sequence, the progressive MAP method criterion is as follows:

\hat{θ}ᵢ⁽ⁿ⁺¹⁾=arg_{θ}_{ᵢ}maxP(χₙ₊₁|θᵢ)P(θᵢ|χ″)

where \hat{θ}ᵢ⁽ⁿ⁺¹⁾ is an estimation value of the model parameter for the first training.

According to the above calculation process, an example is given below in a simpler form.

In the voice recognition system of the exemplary embodiments of the present disclosure, the purpose for recognizing the speaker is to determine to which one of N speakers the voice signal to be recognized belongs. In a closed speaker set, it is only needed to determine to which speaker of the voice database the voice belongs. The recognition task aims at finding a speaker i*, the model λ_{i*} corresponding to the speaker i* enables that the voice feature vector group X to be recognized has the maximum posterior probability (λᵢ/X). According to the Bayes theory and the above formula (3), the maximum posterior probability can be represented as follows:

$$P ( {λ}_{i} / X ) = \frac{P ( X / {λ}_{i} ) P ( {λ}_{i} )}{P ( X )}$$

herein, referring to the above formula 2:

$$P ( X / λ ) = {\prod }_{t = 1}^{T} P ( {X}_{t} / λ )$$

its logarithmic form is:

$$log P ( X / λ ) = {\sum }_{t = 1}^{T} log P ( {X}_{t} / λ )$$

Since the priori probability of P(λᵢ) is unknown, it is assumed that the probability that the voice signal to be recognized comes from each speaker in the closed set is equal, that is:

$$P ( {λ}_{i} ) = \frac{1}{N} , 1 \leq i \leq N$$

For a determined observed value vector X, P(X) is a determined constant value, and thus is equal for all the speakers. Therefore, the maximum value of the posterior probability can be obtained by calculating P(X/λᵢ). Therefore, recognizing to which speaker in the voice database the voice belongs can be represented as follows:

$${i}^{*} = arg {max}_{i} P ( X / {λ}_{i} )$$

The above formula is corresponding to the formula (3), and i* is the identified speaker.

Further, by using the above way, only the closest user in the model database is identified. After the likelihood of the speaker to be recognized and the information of all speakers in the voice database is calculated when the matching is performed, it is further needed to match the voice model of the user having the maximum likelihood relative to the voice signal to be recognized with the recognition threshold limitation and determine the user that the voice signal to be recognized belongs to through a determining unit, so as to achieve the purpose of authenticating the identity of the speaker.

The above voice recognition system further comprises the determining unit used for comparing the voice model having a maximum likelihood relative to the voice signal to be recognized with a preset recognition threshold and determining the user that the voice signal to be recognized belongs to.

FIG. 4 illustrates a schematic diagram of a voice output frequency adopting a MEL filter. The level of voice heard by human ears does not have a linear propositional relation with the voice frequency, while the use of the Mel frequency scale is more in line with the hearing characteristics of the human ears. The so-called Mel frequency scale has a value in general corresponding to the logarithmic distribution relation of the actual frequency. The specific relation of the Mel frequency and the actual frequency can be represented by the equation of: Mel(f)=25951 g(1+f/700). Here, the unit of the actual frequency f is Hz. The critical frequency bandwidth changes with the variation of the frequency, has a consistent increase with the Mel frequency, is below 1000 Hz, presents approximately a linear distribution, has a bandwidth of about 100 Hz and increases logarithmically above 1000 Hz. Similar to the division of critical band, the voice frequency can be divided into a series of triangle filter sequences, i.e., a group of Mel filters. An output of the triangle filter is:

$${Y}_{i} = {\sum }_{k = {F}_{i - 1}}^{{F}_{i}} \frac{k - {F}_{i - 1}}{{F}_{i} - {F}_{i - 1}} {X}_{k} + {\sum }_{k = {F}_{i + 1}}^{{F}_{i + 1}} \frac{{F}_{i + 1} - k}{{F}_{i + 1} - {F}_{i}} {X}_{k} , i = 1 , 2 , … , P$$

where Yᵢ is the output of the i^{th} filter.
The filter output is converted to the cepstrum domain by the discrete cosine transform (DCT):

$${C}_{k} = {\sum }_{j = 1}^{24} log ( {Y}_{i} ) cos [ k ( j - \frac{1}{2} ) \frac{π}{24} ] , k = 1 , 2 , … , P$$

where P is the order of the MFCC parameter, and in the actual software algorithm, P=12 is selected, and thus {Cₖ}_{k=1, 2, . . . , 12} is the calculated MFCC parameter.

The voice recognition system of the exemplary embodiments of the present disclosure analyzes the voice characteristics starting from the principle of the voice producing, and establishing the voice feature model of the speaker by using the MFCC parameter to realize the feature recognition algorithm of the speaker. The purpose of increasing the reliability of speaker detection can be achieved, and the function of recognizing the speaker can finally be implemented on the electronic products.

The above descriptions are only illustrative embodiments of the present disclosure. It should be noted that various improvements and modifications can be made without departing from the principle of the present disclosure for those skilled in the art and these improvements and modifications should be deemed as falling into the protection scope of the present disclosure.

1. A voice recognition system, comprising:
a storage unit for storing at least one of voice models of users;
a voice acquiring and preprocessing unit for acquiring a voice signal to be recognized, performing a format conversion and encoding of the voice signal to be recognized;
a feature extracting unit for extracting a voice feature parameter from the encoded voice signal to be recognized;
a mode matching unit for matching the extracted voice feature parameter with at least one of said voice model and determining the user that the voice signal to be recognized belongs to.

2. The voice recognition system according to claim 1, wherein after the voice signal to be recognized is acquired, the voice acquiring and preprocessing unit is further used for amplifying, gain controlling, filtering and sampling the voice signal to be recognized in sequence, then performing a format conversion and encoding of the voice signal to be recognized so that the voice signal to be recognized is divided into a short-time signal composed of multiple frames.

3. The voice recognition system according to claim 2, wherein the voice acquiring and preprocessing unit is further used for pre-emphasis processing the format-converted and encoded voice signal to be recognized with a window function.

4. The voice recognition system according to claim 1, further comprises:
an endpoint detecting unit for calculating a voice starting point and a voice ending point of the format-converted and encoded voice signal to be recognized, removing a mute signal in the voice signals to be recognized and obtaining a time-domain range of the voice in the voice signal to be recognized; and used for making an analysis of the fast Fourier Transform FFT on voice spectrum in the voice signal to be recognized and calculating a vowel signal, a voiced sound signal and a voiceless consonant signal in the voice signal to be recognized according to an analysis result.

5. The voice recognition system according to claim 1, wherein the feature extracting unit obtains the voice feature parameter by extracting a Mel frequency cepstrum coefficient MFCC feature from the encoded voice signal to be recognized.

6. The voice recognition system according to claim 5, further comprises: a voice modeling unit for establishing a Gaussian mixture model being independent of a text as an acoustic model of the voice with the frequency cepstrum coefficient MFCC by using the voice feature parameter.

7. The voice recognition system according to claim 7, wherein the mode matching unit matches the extracted voice feature parameter with at least one of the voice models by using the Gaussian mixture model and adopting a maximum posterior probability MAP algorithm to calculate a likelihood of the voice signal to be recognized and each of the voice models.

8. The voice recognition system according to claim 7, wherein the mode of matching the extracted voice feature parameter with at least one of the voice models by using the maximum posterior probability MAP algorithm and determining the user that the voice signal to be recognized belongs to, adopts the following formula:
$${{θ}^{⋒}}_{i} = {arg}_{{θ}_{i}} max P ( θ \vert χ ) = {arg}_{{θ}_{i}} max \frac{P ( χ \vert {θ}_{i} ) P ( {θ}_{i} )}{P ( χ )}$$
where θᵢ represents a model parameter of the voice of the i^{th} speaker stored in the storage unit, χ represents a feature parameter of the voice signal to be recognized; P(χ), P(θᵢ) represent a priori probability of θᵢ, χ respectively; P(χ/θᵢ) represents a likelihood estimation of the feature parameter of the to-be-identified voice speech relative to the i^{th} speaker.

9. The voice recognition system according to claim 8, wherein by using the Gaussian mixture model, the feature parameter of the voice signal to be recognized is uniquely determined by a set of parameters {wᵢ′ \vec{μ}ᵢ′ Cᵢ}, where wᵢ, \vec{μ}ᵢ, C₁ represent a mixed weighted value, a mean vector and a covariance matrix of the voice feature parameter of the speaker.

10. The voice recognition system according to claim 7, further comprises a determining unit used for comparing the voice model having a maximum likelihood relative to the voice signal to be recognized with a predetermined recognition threshold and determining the user that the voice signal to be recognized belongs to.

11. The voice recognition system according to claim 1, wherein the voice acquiring and preprocessing unit is further used for pre-emphasis processing the format-converted and encoded voice signal to be recognized with a window function.

12. The voice recognition system according to claim 2, further comprises:
an endpoint detecting unit for calculating a voice starting point and a voice ending point of the format-converted and encoded voice signal to be recognized, removing a mute signal in the voice signals to be recognized and obtaining a time-domain range of the voice in the voice signal to be recognized; and used for making an analysis of the fast Fourier transform FFT on voice spectrum in the voice signal to be recognized and calculating a vowel signal, a voiced sound signal and a voiceless consonant signal in the voice signal to be recognized according to an analysis result.

13. The voice recognition system according to claim 3, further comprises:
an endpoint detecting unit for calculating a voice starting point and a voice ending point of the format-converted and encoded voice signal to be recognized, removing a mute signal in the voice signals to be recognized and obtaining a time-domain range of the voice in the voice signal to be recognized; and used for making an analysis of the fast Fourier transform FFT on voice spectrum in the voice signal to be recognized and calculating a vowel signal, a voiced sound signal and a voiceless consonant signal in the voice signal to be recognized according to an analysis result.

14. The voice recognition system according to claim 2, wherein the feature extracting unit obtains the voice feature parameter by extracting a Mel frequency cepstrum coefficient MFCC feature from the encoded voice signal to be recognized.

15. The voice recognition system according to claim 3, wherein the feature extracting unit obtains the voice feature parameter by extracting a Mel frequency cepstrum coefficient MFCC feature from the encoded voice signal to be recognized.

16. The voice recognition system according to claim 4, wherein the feature extracting unit obtains the voice feature parameter by extracting a Mel frequency cepstrum coefficient MFCC feature from the encoded voice signal to be recognized.

17. The voice recognition system according to claim 14, further comprises: a voice modeling unit for establishing a Gaussian mixture model being independent of a text as an acoustic model of the voice with the frequency cepstrum coefficient MFCC by using the voice feature parameter.

18. The voice recognition system according to claim 15, further comprises: a voice modeling unit for establishing a Gaussian mixture model being independent of a text as an acoustic model of the voice with the frequency cepstrum coefficient MFCC by using the voice feature parameter.

19. The voice recognition system according to claim 16, further comprises: a voice modeling unit for establishing a Gaussian mixture model being independent of a text as an acoustic model of the voice with the frequency cepstrum coefficient MFCC by using the voice feature parameter.
